(19) United States
(12) Patent Application Publication
(10) Pub. No.: US 2016/0237318 A1
(43) Pub. Date: Aug. 18, 2016

(54) SEALANT FILM WITH CONTROLLED SLIP SYSTEM

(71) Applicant: INTEPLAST GROUP CORPORATION, Livingston, NJ (US)

(72) Inventor: Dennis L. Turnage, Chatsworth, GA (US)

(73) Assignee: INTEPLAST GROUP CORPORATION, Livingston, NJ (US)

(21) Appl. No.: 15/047,290

(22) Filed: Feb. 18, 2016

Related U.S. Application Data
(60) Provisional application No. 62/117,787, filed on Feb. 18, 2015.

(51) Int. Cl. C09J 7/00; C09J 11/06; B32B 27/36; B32B 27/08; B32B 27/32

(52) U.S. Cl. CPC C09J 7/00; B32B 27/08; B32B 27/32; B32B 27/36; C09J 11/06; B32B 2250/24; B32B 2307/746; B32B 2405/00; B32B 2439/70; C09J 2201/36; C09J 2205/102; C08K 5/20

(57) ABSTRACT

A sealant film comprising a central core layer, a sealant layer on one side the core layer, and a treated layer on another side of the core layer. The central core layer comprises HDPE, and the sealant layer contains a migratory slip agent which is inhibited from migrating through the core layer to the treated layer.

### FIELD OF THE INVENTION

The present invention generally relates to sealant film for use in plastic films for forming bags and packaging materials.

### BACKGROUND OF THE INVENTION

Sealant films are widely used in bag and packaging applications for items such as food packaging bags and pouches. It is known to use slip agents to control the coefficient of friction (COF) of polyolefin and other films. Slip agents are generally low molecular weight, polar molecules whose small size and incompatibility with thin film compositions allows them to migrate to the surfaces of the thin films. These molecules at the film surface modify surface characteristics by reducing friction. The migration is also referred to as “bloom,” and occurs relatively quickly upon extrusion of the films so that the surface modifications occur during the early processing stages of the films.

The use of slip agents to control COF is described in U.S. Pat. No. 7,267,862, which discloses films containing a blend of multiple slip agents wherein the blends include both faster migrating primary amide slip agents and slower migrating secondary amide slip agents. This use of blends of slip agents is stated to address problems associated with unpredictability in using low amounts of slip agents in a variety of films to produce films having moderate slip, moderate slip being so-called medium and medium-high slip in contrast to high slip and no slip. This use of blends is also stated to address problems resulting from absorption of slip agents by adhesives, inks, and other films to which the films are laminated.

### SUMMARY OF THE INVENTION

Among the several objects of the invention, therefore, is a sealant film with controlled COF characteristics; a sealant film with reduced absorption of slip agents by inks, adhesives, and other films to which the sealant film is laminated to; and a sealant film with a COF on the sealant film surface which is consistently and reliably maintained in the desired range throughout the manufacturing process.

Briefly, therefore, the invention is directed to a sealant film for packaging comprising a central core layer; a sealant layer on one side the core layer; and a treated layer on another side of the core layer; wherein the central core layer, sealant layer, and treated layer are coextruded; wherein the central core layer comprises between 35 and 45 wt % of HDPE; and wherein the sealant layer contains between about 0.2 and about 0.6 wt % such as between about 0.3 and about 0.6 wt % of a migratory slip agent.

In another aspect, the invention is directed to a packaging film comprising a structural film and a sealant film laminated to the structural film, wherein the sealant film comprises a central core layer; a sealant layer on one side the core layer; and a treated layer on another side of the core layer; wherein the central core layer, sealant layer, and treated layer are coextruded; wherein the central core layer comprises between 35 and 45 wt % of HDPE; and wherein the sealant layer contains between about 0.2 and about 0.6 wt % such as between 0.3 and about 0.6 wt % of a migratory slip agent.

The invention is also directed to a method for forming the foregoing multilayer films, and to packaging comprising the foregoing films.

Other objects and features will be in part apparent and in part pointed out hereinafter.

### BRIEF DESCRIPTION OF THE FIGURES

FIG. 1 is a schematic illustration of a multi-layer sealant film of the invention.

FIG. 2 is a schematic illustration of packaging film incorporating a multi-layer sealant film of the invention.

FIG. 3 is a schematic illustration of two layers on a roll of packaging film incorporating a multi-layer sealant film of the invention.

FIG. 4 is a chart showing COF plotted against time for a PET surface and a PE surface of a composite film comprising a PET film laminated to a sealant film of the invention.

### DETAILED DESCRIPTION OF THE INVENTION

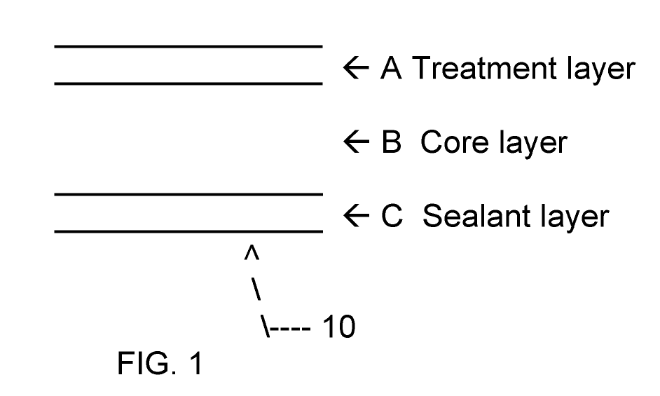

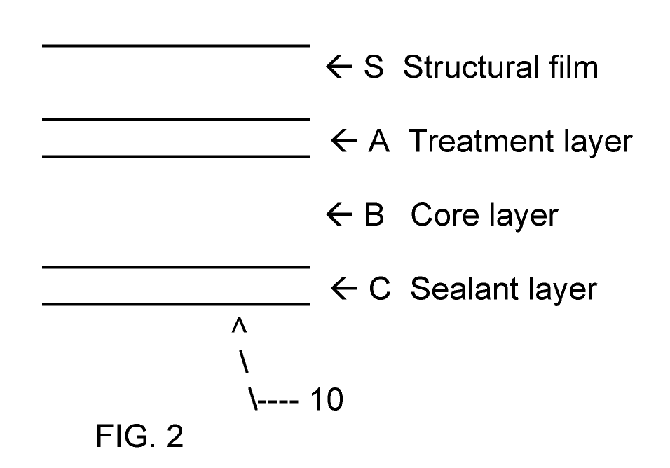

The present invention is directed to a sealant film that contains at least three co-extruded layers: a treated layer on one side of a central core layer, the central core layer, and a sealant layer on the other side of the core layer. These layers are layers A, B, and C, respectively, in FIG. 1, in a preferred embodiment where the treated and sealant layers are not only on each side of the core layer, but are also in direct contact with the core layer. Layer A is referred to as a treated layer or treatment layer because it is intended to receive a surface treatment at some point during the overall film manufacture such as a corona treatment, chemical treatment, or flame treatment. One purpose of such treatment is to enhance bonding with a structural film which functions as a lamination substrate. The sealant layer contains a slip agent. In one preferred embodiment, the sealant film contains exactly these three layers. In another preferred embodiment, the sealant film is a component of a composite film such as shown in FIG. 2, with one or more additional films in addition to the multi-layer sealant film. In one embodiment, an additional film is based on polyethylene terephthalate (PET). In other embodiments, the additional film is, for example, based on oriented polypropylene (OPP), biaxially oriented polypropylene (BOPP), or biaxially oriented nylon (BON).

### Treated Layer

The composition of the treated layer in the co-extruded film of the invention is dictated by the ultimate application of the film and is not narrowly critical to the efficacy of the invention. In one embodiment, for example, the treated layer comprises LLDPE, LDPE, and antiblock (NB). Other additives may be included depending on the application. For purposes of illustration only, a treated layer for a film for use in food packaging or other packaging may contain 50 to 65 wt % LLDPE, 35 to 45 wt % LDPE, and 1 to 5 wt % NB concentrate (e.g., 25% antiblock balanced with LDPE). All percentages herein are by weight unless stated otherwise.

### Core Layer

The core layer of the sealant film of the invention contains a high density polyethylene (HDPE) component as a primary functional component. The main function of the HDPE component of the core layer is to inhibit migration of the slip agent through the core layer. In a currently preferred embodiment, the HDPE component constitutes from about 35 to about 45 wt % of the core layer, such as between 38 and 42 wt %, or about 40 wt %. Using less than about 35% HDPE risks not sufficiently inhibiting migration of the slip agent through the core layer. Using more than about 45% HDPE risks imparting haze, wrinkles, and too much stiffness. In some embodiments, the HDPE used in the core layer has a relatively high density of, e.g., 0.962 g/cc. By general definition, HDPE materials have a density>0.94. As density of PE materials increases, the materials have a higher crystallinity, which in the context of this invention is believed to be associated with more effective barrier properties. In the current invention, therefore, it is preferred that the density of the HDPE is greater than 0.95, preferably greater than 0.955, such as greater than 0.960 g/cc. The constitution of the remainder of the core layer is not narrowly critical to the films of the invention. For example, the remainder of the core layer may be any one or more plastics selected from among LDPE, LLDPE, PE copoloymers and combinations thereof. In one current embodiment, this additional component of the central core layer is a C6 linear low density polyethylene (LLDPE) polymer, and constitutes 55 to 65 wt % of the central core layer.

### Sealant Layer

The sealant layer of the co-extruded sealant film of the invention contains a migratory slip agent. The purpose of a slip agent is to control the coefficient of friction (COF) on the surface of a film. COF values range from 0.00-1.00, with lower values signaling lesser resistance to sliding, or higher slip. Too much friction—too high of a COF—of the sealant side of the film can lead to film dragging or jamming as it passes over plates during forming. Too much friction of the sealant side of the film can also cause poor film feeding over forming elements, inconsistent package sizes, and squealing, and can cause lateral slipping and poor seals, and inhibited (slow) delivery. Films with too little friction tend to fall off inclined conveyor systems, and tend to slide off film stacks. Film COF can be controlled by adding a slip agent to the film composition. A slip agent is incompatible with the film resin, such that over time the slip agent migrates to the film surface where it impacts the surface friction characteristics.

The inventors have discovered that by incorporating a high proportion of HDPE into the core layer, a migratory slip agent can be used in the sealant layer without risk of the slip agent migrating through the core layer to the treated layer or to a structural layer to which the treated layer is laminated. This permits the film to take advantage of the benefits of a migratory slip agent, without suffering certain disadvantages of a migratory slip agent. In particular, this facilitates use of a migratory slip agent characterized by continual migration of the slip agent from the bulk of the sealant layer to the film surface on the sealant side of the film, where it advantageously maintains the desired lower COF. This lower COF on the sealant layer surface—surface 10 in FIG. 1—helps avoid the above disadvantages of having too much friction. And, while it is desirable for slip agent to migrate to the film surface on the sealant side surface 10 of the film, it is undesirable for slip agent to migrate through the core layer to the treated layer side of the film. In particular, it is undesirable for slip agent to migrate through the core layer to the treated layer side of the film because slip agents interfere with bonding between the treated layer and another film such as a PET structural film to which the treated layer is to be laminated. Because the films of the invention contain HDPE in the core layer which inhibits slip agent migration through the core to the treated layer and treated layer surface, a migratory slip agent can be used in the sealant layer with reduced tendency toward the disadvantages of slip agent migration through the core layer to the treated layer. A further advantage of this arrangement is that non-migratory slip agents can be avoided. This is advantageous because non-migratory or so-called permanent slip agents tend to reduce film clarity. Furthermore, in the subsequent converting processes (e.g., lamination to PET film and converting to bag), the sealant film has to pass through rollers that may scrub the slip agents from the film surface. A migratory slip agent can continue to supply the loss of slip agent by continual migration to the surface from the bulk of the sealant layer. However, a non-migratory slip agent cannot supplement the loss since it cannot migrate.

The sealant layer of the film is formulated to contain a loading of at least about 0.2 wt % migratory slip agent in the sealant layer, such as between 0.2 and 0.6 wt %, such as between 0.3 and 0.5 wt %, or about 0.4 wt %. Inasmuch as a slip concentrate contains on the order of 10% slip agent compound in a carrier (e.g., LLDPE), these loadings translate to at least about 2 wt % slip agent concentrate in the sealant layer, such as between 2 and 6 wt %, such as between 3 and 5 wt %, or about 4 wt %.

A currently preferred embodiment of the invention employs a bis amide as the slip agent. This is in contrast to a mono amide such as erucamide (C₂₁H₄₁CONH₂) based slip agents used in the prior art. Without being bound to a particular theory, it is preliminarily postulated that the larger molecule size and the branching of a bis amide with an unsaturated fatty acid facilitates the invention because such molecules—in contrast to mono amides—can be blocked by HDPE in the core layer. Notwithstanding the molecule size and branching, the molecule is sufficiently migratory to perform its function in the sealant layer of continual migration to the sealant layer surface. A currently preferred embodiment therefore uses a bis amide based slip agent. In one such embodiment, the bis amide based slip agent is the only slip agent in the sealant layer, and the sealant layer is affirmatively devoid of mono amide based slip agents. In one aspect, therefore, the sealant layer and sealant film contain no slip agents other than the bis amide slip agent. The reference to “no slip agents” such as “no mono amide slip agents” or “no slip agents other than bis amide” herein in this context means that there is no amount that has any significant impact on performance; but this reference does not exclude minor trace amounts akin to contamination. This reference also includes the situations where there are absolutely no such other agents.

Ethylene bisoleamide [(C₁₇H₃₃CONH₂)₂(CH₂)₂] is a species of bis amide with unsaturated fatty acid which has proven to be effective. Other candidate bis amides include, for example, hexamethylenebis oleamide, N,N′-dioleyl adipamide, and others. A suitable migratory slip agent for use in this invention available under the trade name Ampacet 102109 from Ampacet Corporation of Tarrytown, N.Y. In a preferred embodiment, the sealant layer contains essentially no permanent (i.e., non-migratory) slip agent, such as less than 0.1 wt % permanent slip agent or absolutely no permanent slip agent. Most preferably, the sealant layer contains only one slip agent, and that is the bis amide based slip agent. In one such embodiment, the only slip agent in the sealant layer is a slip agent that contains ethylene bisoleamide.

Apart from the migratory slip agent, the selection of other components of the sealant layer is not narrowly critical to the composition of the sealant layer. For example, in one embodiment, the sealant layer also comprises 40-60% mLL, 5-15% elastomer of PE copolymer, 20-40% LD, and 1-3% A/B concentrate.

The sealant films of the invention are useful in applications requiring a medium-high slip (COF from about 0.15 to 0.30) or medium slip film (COF from about 0.2 to 0.5). These are distinguished from non-slip films which have a COF value of above about 0.4 and from high slip films which have a COF value below about 0.20, such as between 0.10 to 0.20.

In accordance with this invention, the COF of the sealant film is controlled so that the COF on the sealant surface remains low for a prolonged period so that it can be processed, transported, stored, and used at a remote customer's location while retaining its desired COF of from about 0.2 to 0.25, for example. Moreover, the COF on the treated layer outer surface is not appreciably impacted by slip agent migration, and is therefore relatively high, such as greater than about 0.35, depending on the film.

As a general proposition, the thickness of the overall sealant film is between about 1 and 6 mils (0.001-0.006 inch). The core layer occupies between 30 and 50% of the thickness, and the sealant and treatment layers each occupy between 20 and 40% of the thickness. For example, the thickness ratio in one embodiment is treated:core:sealant=30/40/30.

### Lamination to PET or Other Film

In one application of the invention, the sealant film is laminated to another film to form a composite film. In these cases, the additional film is based on, for example, PET, OPP, BOPP, or BON, as mentioned above. An example of this is shown schematically in FIG. 2. The additional film is structural film S. The HDPE in the core layer B inhibits migration of migratory slip agent from the sealant layer C up through the core layer to the treated layer and structural film S of PET or the like. This is important because films such as nylon and PET have a high affinity for slip agents. So without the HDPE in the core layer to inhibit migration, there would be substantial migration of slip agent up to the PET or other structural film. One negative effect of prior arrangements where slip agent migrates up to the PET or other structural film is that migration of slip agent to the treated layer and structural film robs the sealant layer of slip agent, which would detract from the ability of the sealant layer to continually supply slip agent to sealant side surface 10 in FIG. 2 where it is desired to maintain low friction and replace slip agent that is scalped off or otherwise lost during film processing as the film passes over rollers, is exposed to heat, etc. Another negative effect of this is that slip agent at the interface between the treated layer and the PET or other structural film can detract from the bonding strength between these two layers. A further negative effect of this is that if there is slip agent in the PET or other structural layer, it can leach off onto machinery, necessitating additional cleaning and maintenance; and lead to inaccurate sizing readings where film glides over machinery without registering correctly, and associated conversion errors.

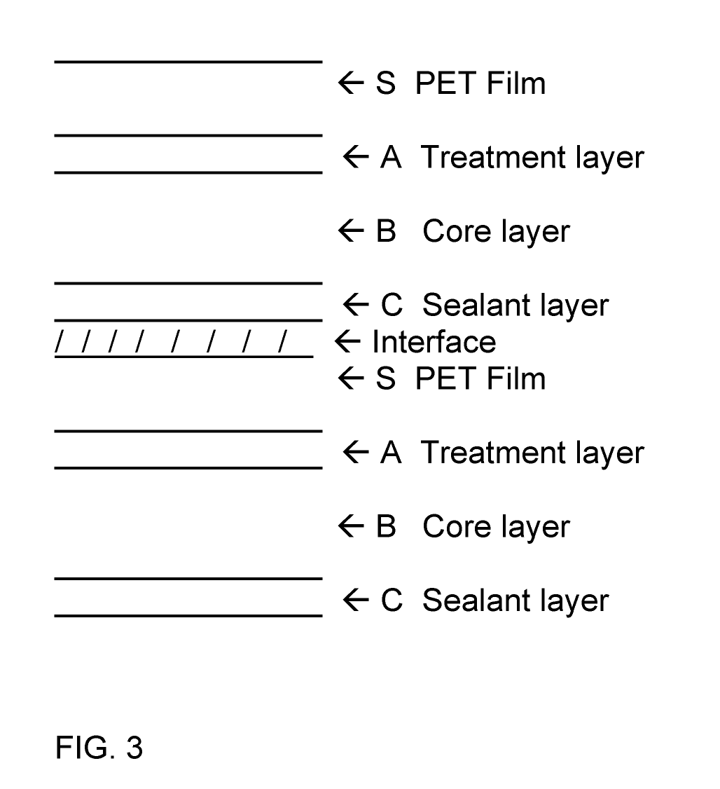

In one situation, the sealant film of the invention is laminated to a PET film to form a composite film which is wound onto a roll. The film from the roll is then converted to a finished product such as bags. While on the roll, there is an interface between layers of film wherein the sealant layer of the composite film is in direct contact with the PET film, as shown in FIG. 3. In prior practice, there would be transfer of slip agent from the polyethylene sealant film to the PET lamination web. The slip on the surface of the lamination web could cause the overall film structure to slip and get out of registration, creating short or long indexes and making incorrectly sized packages. The present invention addresses this issue by using a migratory slip agent that migrates to the surface 10 of the sealant film but is significantly non-transferable in that it does not easily transfer across to the PET or other lamination film.

The invention is further illustrated by the following working example.

### EXAMPLE

A sealant film was manufactured by dry blending compositions as follows for each of the three layers. A treated layer composition was prepared by blending 59% C8 LLDPE (density: 0.922 g/cc, melt flow: 1.0 gram/10 minutes), 39% LDPE (density: 0.923 g/cc, melt flow: 2.0 gram/10 minutes), and 2% A/B concentrate (25% diatomaceous earth antiblock in 75% LLDPE). A core layer composition was prepared by blending 60% hexene C6 LLDPE (density: 0.918 g/cc, melt flow: 1.0 gram/10 minutes) and 40% HDPE (density: 0.962 g/cc, melt flow: 1.0 gram/10 minutes). A sealant layer composition was prepared by blending 51% C6 LLDPE (density: 0.918 g/cc, melt flow: 1.0 gram/10 minutes), 10% elastomer of PE copolymer (density: 0.874 g/cc, melt flow: 1.1 gram/10 minutes), 32% LDPE (density: 0.923 g/cc, melt flow: 2.0 gram/10 minutes), 2% A/B concentrate (25% A/B (diatomaceous earth) balanced with LLDPE), and 4% migratory slip agent concentrate (Ampacet 102109) containing about 10% slip agent in LLDPE, such that the slip agent itself constitutes on the order of 0.4% of the sealant layer. The three layer compositions were extruded on a commercially available 3-layer blown film line at normal processing conditions recommended by the major resin suppliers. The resulting co-extruded three layer film had a thickness of 2.25 mils, with a treated layer thickness of about 30%, a core layer thickness of about 40%, and a sealant layer thickness of about 30%.

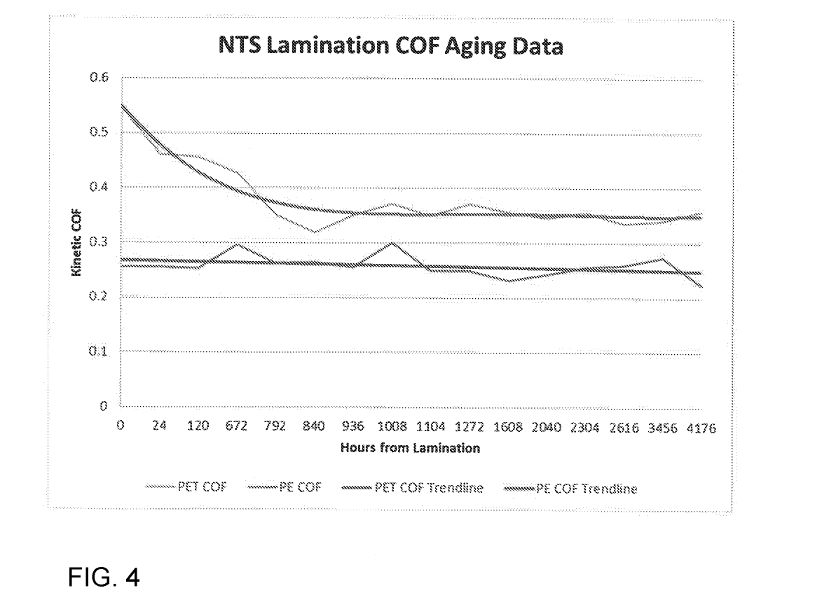

In one test, the sealant film was laminated to a PET structural film. The composite film is wound onto a roll. The COFs of both sides of the film sampled from the roll were monitored over time. The COF of each side (PET/structural side and sealant surface side) stabilized and that of the PET side did not continue to go down over time after the initial stabilization period. The COF of the PET side stabilized after about 30 days. In particular, between 30 days and 150 days, COF measurements of the structural film side did not appreciably change, i.e., the measurements were all within 10% of each other. This consistency in COF measurements is attributed to two aspects of the invention: a) the HDPE in the core layer interaction with the preferred slip agent to inhibit migration of the slip agent from the sealant layer side of the film to the structural layer side of the film, and b) the non-transferable nature of the slip agent such that transfer from the sealant layer surface to the structural layer surface across the interface (FIG. 3) while on the roll is inhibited. Accordingly, in situations when the film is stored for longer periods of time prior to use, the invention is proven to inhibit transfer of slip from the PE film side to the PET film side in storage on a roll, so that when this film is next run at some time in the future, it will perform just as it did when it was fresh from the converter. FIG. 4 is a chart showing COF plotted against time for a PET surface and a PE surface of a composite film comprising a PET film laminated to a sealant film of the invention. This shows that the COF of the sealant side surface (PE COF) was stable through over 4000 hours and the COF of the structural (PET) film surface was stable after initial stabilization.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above products and methods without departing from the scope of the invention, it is intended that all matter contained in the above description shall be interpreted as illustrative and not in a limiting sense.

What is claimed is:

1. A sealant film comprising:
a central core layer;
a sealant layer on one side the core layer; and
a treated layer on another side of the core layer;
wherein the central core layer, sealant layer, and treated layer are coextruded;
wherein the central core layer comprises between 35 and 45 wt % of HDPE;
wherein the sealant layer contains between 0.2 and 0.6 wt % of a migratory slip agent.

2. The sealant film of claim 1 wherein the migratory slip agent comprises a bis amide.

3. The sealant film of claim 2 wherein the bis amide comprises ethylene bisoleamide.

4. The sealant film of claim 1 wherein the sealant layer contains no slip agent other than the migratory slip agent.

5. The sealant film of claim 1 wherein the sealant film contains no slip agent other than the migratory slip agent in the sealant layer.

6. The sealant film of claim 2 wherein the sealant layer contains no slip agent other than the bis amide slip agent.

7. The sealant film of claim 2 wherein the sealant film contains no slip agent other than the bis amide slip agent in the sealant layer.

8. The sealant film of claim 3 wherein the sealant layer contains no slip agent other than the ethylene bisoleamide slip agent.

9. The sealant film of claim 3 wherein the sealant film contains no slip agent other than the ethylene bisoleamide slip agent in the sealant layer.

10. The sealant film of claim 1 wherein the sealant layer contains no mono amide slip agent compounds.

11. The sealant film of claim 1 wherein the sealant film contains no mono amide slip agent compounds.

12. The sealant film of claim 1 wherein the sealant film is laminated to a structural film.

13. The sealant film of claim 12 wherein the structural film is a PET film.

14. The sealant film of claim 12 wherein the migratory slip agent comprises a bis amide.

15. The sealant film of claim 13 wherein the bis amide comprises ethylene bisoleamide.

16. The sealant film of claim 12 wherein the sealant film contains no slip agent other than the migratory slip agent in the sealant layer.

17. The sealant film of claim 14 wherein the sealant film contains no slip agent other than the bis amide slip agent in the sealant layer.

18. The sealant film of claim 15 wherein the sealant film contains no slip agent other than the ethylene bis oleamide slip agent in the sealant layer.

19. The sealant film of claim 12 wherein the sealant film contains no mono amide slip agent compounds.

20. The sealant film of claim 1 incorporated into packaging.
